(19) United States
(12) Patent Application Publication
(10) Pub. No.: US 2014/0021645 A1
(43) Pub. Date: Jan. 23, 2014

(54) METHOD OF LAYERED CONSTRUCTION OF POLYMERIC MATERIAL THROUGH OPEN-CELL POROUS MATERIAL MATRIX

(71) Applicants: Nassif Elias Rayess, Warren, MI (US); Marcos Zamora, Detroit, MI (US)

(72) Inventors: Nassif Elias Rayess, Warren, MI (US); Marcos Zamora, Detroit, MI (US)

(21) Appl. No.: 13/916,473

(22) Filed: Jun. 12, 2013

Related U.S. Application Data
(60) Provisional application No. 61/658,900, filed on Jun. 12, 2012.

(51) Int. Cl. B29C 45/14

(52) U.S. Cl. CPC B29C 45/14
USPC 264/69; 264/265; 264/572

(57) ABSTRACT

A method for constructing layers of polymers through a core of open cell porous material such as metal foams is provided comprising the use of temporary filler material to fill certain volumes within the cellular material. This is followed by filling the remaining volume with polymeric material. The temporary filler material is then removed revealing a layer of a composite of polymer and cellular material as well as a layer of unfilled cellular material. The process can then be repeated to create other layers using same or different polymer.

### CROSS-REFERENCE TO RELATED APPLICATIONS

The present application claims priority under 35 USC §119 based on U.S. Provisional Application No. 61/658,900 filed on Jun. 12, 2012. The entire subject matter of this priority document is herein incorporated by reference.

### BACKGROUND OF THE INVENTION

1. Field of the Invention

The present invention relates to a method for combining polymeric material with open-cell porous material and more specifically, it relates to a method for combining said materials in a prescribed manner to effect layered construction of various precise geometries.

2. Description of the Background Art

Metallic cellular materials, such as metal foams, have a high stiffness to weight ratio among a number of other functional advantages. These functionalities can be further enhanced by precisely filling the open pores of the cellular materials with various compounds, thus creating what is known as multi-functional material.

There are two general categories of cellular materials and foams: ones having closed cells and others with open cells. The ones with closed cells are made by introducing voids in the material which result in cells and pores that are enclosed by wall-like structures. As technology continues to improve, the cell walls of closed cell foams have become very thin and fragile while maintaining the bulk strength of the material. The ones with open cells consist of networks of interconnected ligaments that allow for large number of voids as well as allowing fairly open fluid flow throughout the material. Closed-cell foams do not allow for fluid flow and that contrast between open and closed cell porous material is of the most relevance to this discussion.

Closed-cell metal foams are coated with plastics in U.S. Pat. No. 3,617,364 (1971) and in U.S. Pat. No. 3,707,401 (1972) to Jarema (plastic coated metallic foams). As the metallic foams used are of the closed-cell variety, the plastics and resins only penetrate the topmost layer of cells, namely those that extend past the cut surface and have thus become open. Jarema discusses the use of a large number of resins, thermoplastics and elastomeric compounds. The processes discussed range from simple brushing of resins to molding of thermoplastics. Left unaddressed are any safeguards to protect the integrity of the cell walls against the excessive fluid pressures encountered in molding processes. Left unsupported, the high pressures of polymer molding can severely and permanently deform the closed cell foam.

Polymeric materials are infiltrated into open-cell foams in U.S. Pat. No. 5,895,726 (1999) to Imam (lightweight high damping porous metal/phtalonitrite composites) and in U.S. Pat. No. 7,632,565 B1 (2009) to Imam (porous metal/organic polymeric composites). The choices of polymer claimed by Imam were of the thermosetting variety which were poured onto the open cell foams and filled the voids in the material with the assist of vacuum.

Thermoplastic polymers were introduced into open cell foams using an injection molding process in the work by Dukhan et. al. [N. Dukhan, N. Rayess and J. Hadley, “Characterization of Aluminum Foam-Polypropylene Interpenetrating Phase Composites: Flexural Test Results,” Mechanics of Materials Journal, 42 (2010), 134-141]. However, this work had no provisions for directing the thermoplastic to predetermined locations within the metal foam core and thus filled the entire volume. However, engineering applications often require the tailoring of the polymer flow in order to achieve desired functions. The absence of the capability to tailor the location of the regions of the cellular material that will be filled by the polymer remains a major drawback and a large impediment to wide scale adoption of metal foams/polymer composites.

### SUMMARY OF THE INVENTION

Accordingly, the present invention has been made to overcome the drawbacks of the previously known methods by impregnating an open-cell porous metal matrix with a polymeric material in a prescribed manner to achieve precise distribution of the polymer within the porous material. For the purposes of this document, the terms “porous” and “cellular” will be used interchangeably. The distribution of the polymer could be tailored such as to achieve sandwich construction or other construction with varying layers and alternate geometries within the cellular matrix.

The method of prescribing the distribution of the polymer throughout the porous material relies on the use of temporary filler material that temporarily occupy certain regions creating a preform around which the polymer flows. The types of temporary filler material consist of granular solids, low melting temperature metals and dissolvable ceramics among others.

The type of porous material consists of open cell metal foams, open cell non-metallic foams, woven wire and other periodic cellular materials as well as honeycomb, corrugated, and other similarly structured material.

The method in this invention is suitable to all type of polymer (thermoplastic as well as thermoset resins, both reinforced and unreinforced) as well as elastomers. The thermoplastic polymers could be introduced into the cellular matrix via injection, compression, or by other molding techniques. The thermosetting resins could be introduced into the cellular matrix either via natural flow or assisted by vacuum or by positive pressure.

There have thus been outlined, rather broadly, some of the features of the invention in order that the detailed description thereof may be better understood, and in order that the present contribution to the art may be better appreciated. There are additional features of the invention that will be described hereinafter.

Other objects, advantages and salient features of the present invention will become apparent to the skilled artisan with reference to the exemplary embodiments of the invention discussed hereafter with reference to the appended drawings. To accomplish the above and related objects, this invention may be embodied in the form illustrated in the accompanying drawings, attention being called to the fact, however, that the drawings are illustrative only, and that changes may be made in the specific construction illustrated and described within the scope the claimed invention.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a view showing the cellular matrix core shaped in a rectangular fashion inside a mold cavity and filled partially with the temporary filler material prior to introducing the polymer.

FIG. 2 is a view showing the cellular matrix core of FIG. 1 after a polymer has filled the remaining voids of the core and any remaining open space of the mold cavity.

FIG. 3 is a view showing the cellular matrix core of FIG. 2 after the temporary filler material have been removed exposing an open cellular material part, a composite of the polymer and cellular material layer and a polymer only layer.

FIG. 4 is a block diagram of the method of manufacturing of this invention.

FIG. 5 is a view showing the cellular core matrix being submerged in a mold cavity containing the temporary filler material with the aim of having said material fill the bottom layer of the voids of the cellular core matrix.

FIG. 6 is a view showing the cellular core matrix partially filled with the temporary filler material in an injection molding mold cavity ready to receive a permanent layer of polymer.

FIG. 7 is a view showing the cellular core matrix submerged in an agitated bath of hot liquid in the process of removing the temporary filler material.

### DETAILED DESCRIPTION OF THE ILLUSTRATIVE EMBODIMENT

### Overview

Turning now descriptively to the drawings, in which similar reference characters denote similar elements throughout the several views, the figures illustrate a mold cavity, cellular matrix core, temporary filler material, temporary filler material introduction apparatus, temporary filler material removal apparatus, polymer filler material and polymer filler material introduction apparatus.

### Cellular Matrix Core

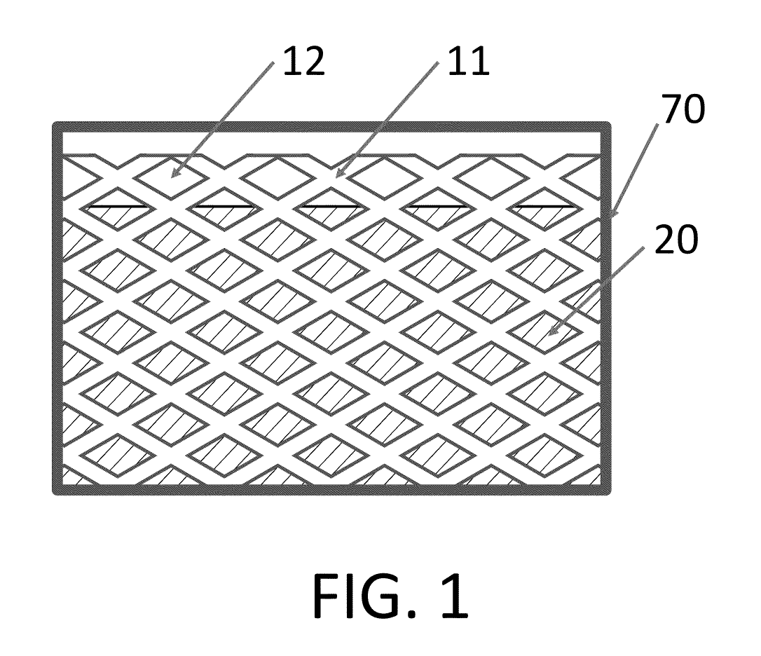

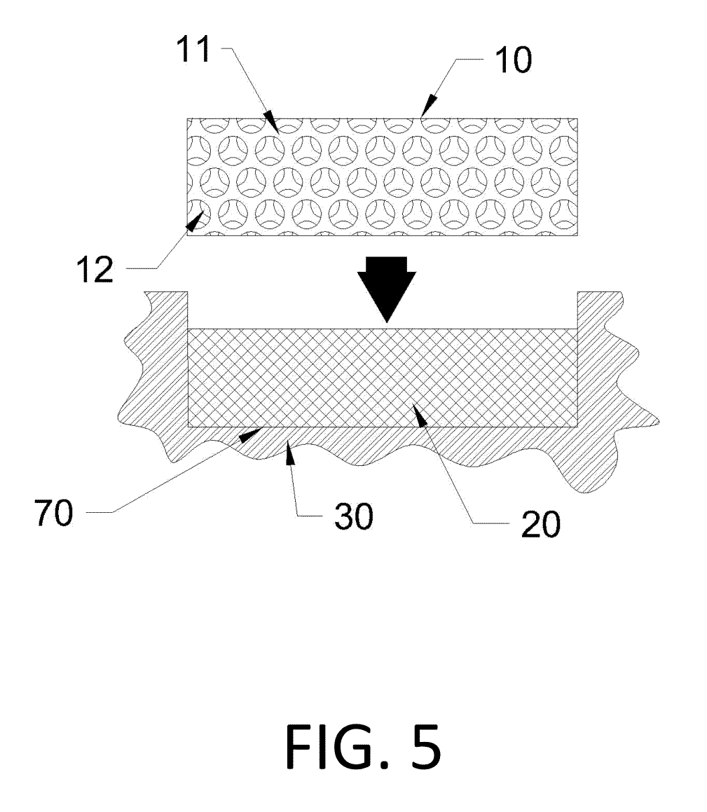

Referring to FIGS. 1 and 5, the cellular matrix core 10 is the scaffold on which the composite material is built. It can be any open-cell porous material such as open cell metal foams, woven wire, honeycomb-like structures and others. The cellular matrix core must possess a contiguous morphology such as networks of interconnected ligaments 11 that form and supports voids 12 within the volume. The cellular matrix core is a rigid material that serves as the skeleton on which the structure is built by the eventual filling of the voids. Being rigid, the cellular matrix core is shaped at or near the desired final form or the form of the mold cavity 70.

The cellular matrix core 10 could be made of a number of possible materials. One possible material is the DuoCell Aluminum Foam™ material or any other open cell metal foams. Other possibilities include woven wire structures or other periodic structural construction such as honeycomb. In essence, any open cell porous material could be used as long as it possesses an interconnecting morphology, meaning that it has the strength to hold its shape under handling and moderate loading.

The cellular matrix core 10 could be shaped to the final size of the part or to a size that is smaller than the final size. In the first case, the final product will have cellular material at the outer surfaces of the mold 70.

### Temporary Filler Material

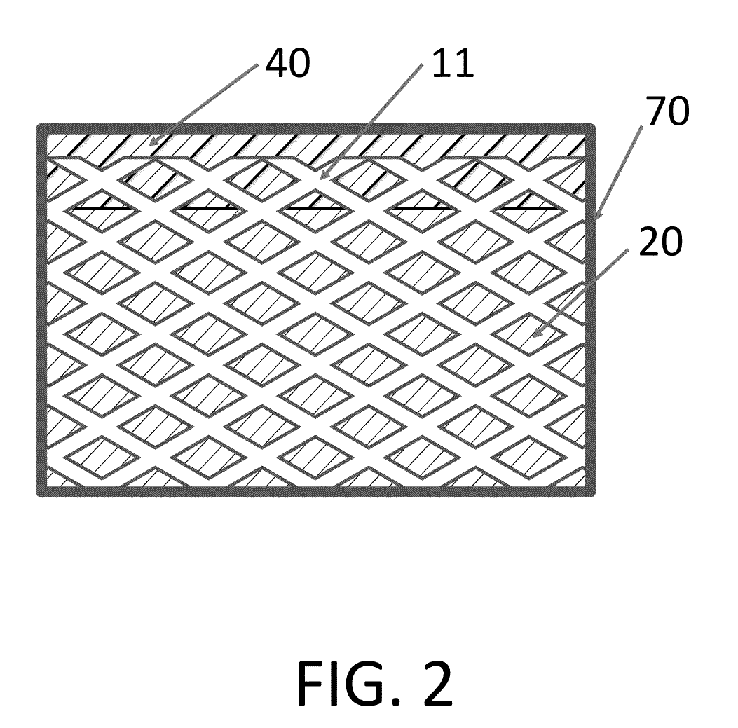

Referring to FIG. 2, the temporary filler material 20 can either be solid or granular material designed to temporarily occupy regions of the cellular matrix core intended to remain unfilled in the final product.

The temporary filler material 20 is any medium able to flow through and temporarily fill the voids 12 of the cellular matrix core 10 without becoming a permanent part of its structure. The temporary filler material of choice is a low melting temperature Bismuth based alloy that melts at a temperature far lower than the glass transition temperatures of most polymers.

The temporary filler material could also be granular materials such as sand, metallic or ceramic shot and/or grit. The temporary filler material is introduced into the cellular matrix core 10 and could be arranged in various geometries including flat geometries as well as other geometries. Possible geometries include but are not limited to multiple parallel layers within the cellular matrix core, diagonal layers, structural supporting ribs and others.

### Temporary Filler Introduction Apparatus

Referring to FIG. 5, the temporary filler introduction apparatus 30 serves the purpose of introducing the temporary filler material 20 at the required locations and geometries within the cellular matrix core 10.

The temporary filler introduction apparatus 30 serves the purpose of ensuring that the temporary filler material 20 is present only in the intended space and completely absent from the space intended to be permanently occupied by the polymer 40. In the preferred embodiment of using a low melting temperature Bismuth alloy as temporary filler material, the temporary filler introduction apparatus 30 is an open cavity that has the shape of the final form. A precise amount of the liquid Bismuth alloy temporary filler material is placed at the bottom and the cellular matrix core 10 is introduced into it. In that case, the liquid Bismuth alloy temporary filler material rises through the cellular matrix core to the exact desired height and never contaminates any other surfaces.

The structure of the temporary filler introduction apparatus 30 depends of the type of temporary filler material 20 chosen. In the case of granular material, the temporary filler introduction apparatus 30 is a shaker apparatus that drives the granular material to the bottom. In the case where a circular geometry of the temporary filler material is required, the temporary filler introduction apparatus 30 would be a rotating centrifuge that locates the material by forcing it to the outer surfaces. If the temporary filler material 20 is either magnetic fluid or ferromagnetic shot, then a magnet could be used to position it within the cellular matrix core 10.

### Polymer Filler Material

Referring to FIG. 2, the polymer filler material 40 is intended to permanently fill the regions within the cellular matrix core not occupied by the temporary filler material. The intent is for the polymer filler material to become a permanent addition to the overall structure adding various thermal, chemical and mechanical properties to those of the cellular matrix core 10. The polymer filler material 40 is introduced into the cellular matrix core 10 using the polymer filler material introduction apparatus 50. The polymer filler material 40 could either bond to the cellular matrix core 10 or become entrapped by the ligaments 11.

The polymer filler material 40 could either be a thermoplastic polymer, a thermosetting polymer or an elastomer. In the case of the polymers, these could either be filled or unfilled. The preferred embodiment is an unfilled thermoplastic polymer.

### Polymer Filler Material Introduction Apparatus

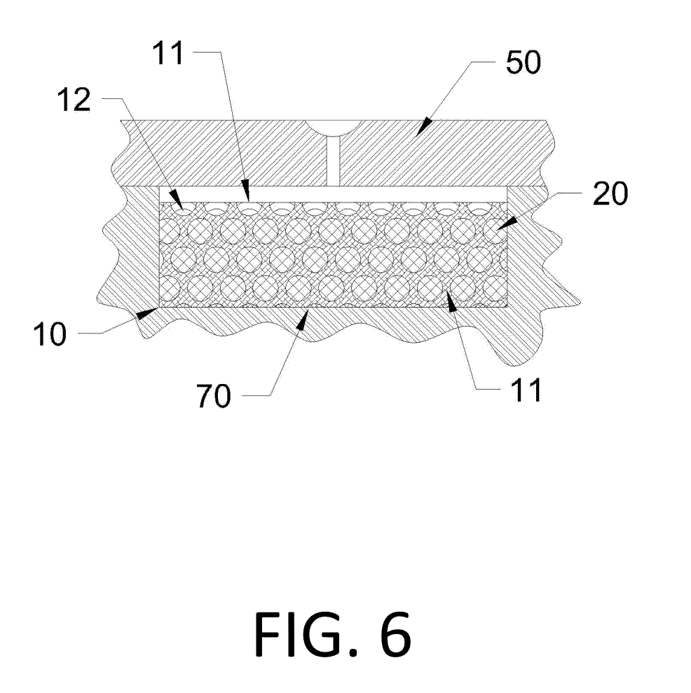

Referring to FIG. 6, the polymer filler material introduction apparatus 50 serves the purpose of adding the polymer filler material following the introduction of the temporary filler material.

The polymer filler material introduction apparatus 50 performs the task of forcing the polymer filler material 40 into the open voids 12 of the cellular matrix core 10 as well as any remaining spaces within the mold cavity 70. In the case of thermoplastic polymers, the polymer filler material introduction apparatus 50 is one of a number of polymer molding equipment with injection molding being the preferred embodiment.

The polymer filler material introduction apparatus 50 depends on the type of the polymer filler material 40. For thermoplastic polymers, this can be one of a number of molding technologies such as injection, compression or blow molding among others. For thermosetting polymers and resins, the polymer filler material introduction apparatus could be a vacuum assist and the curing could employ an autoclave to maintain the needed temperature and pressure during the curing process.

### Temporary Filler Material Removal Apparatus

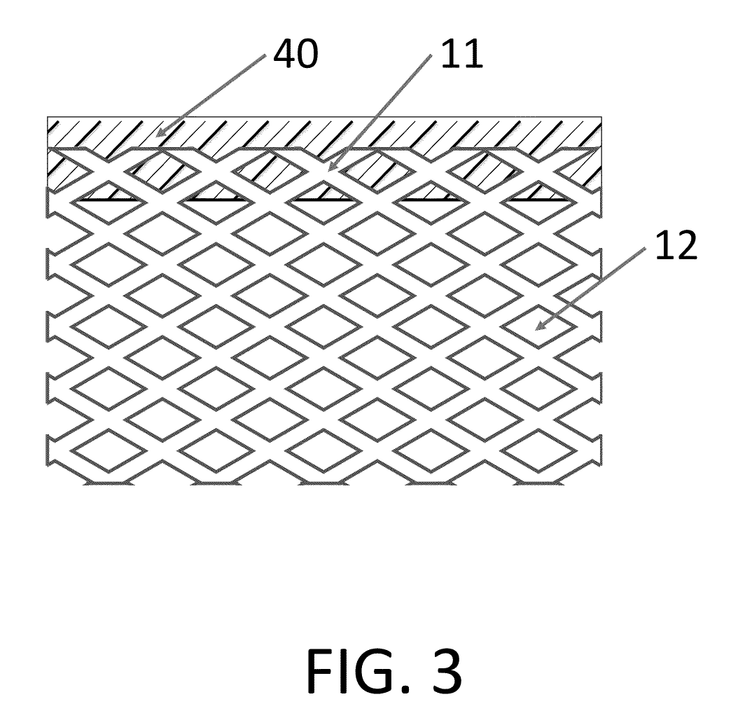

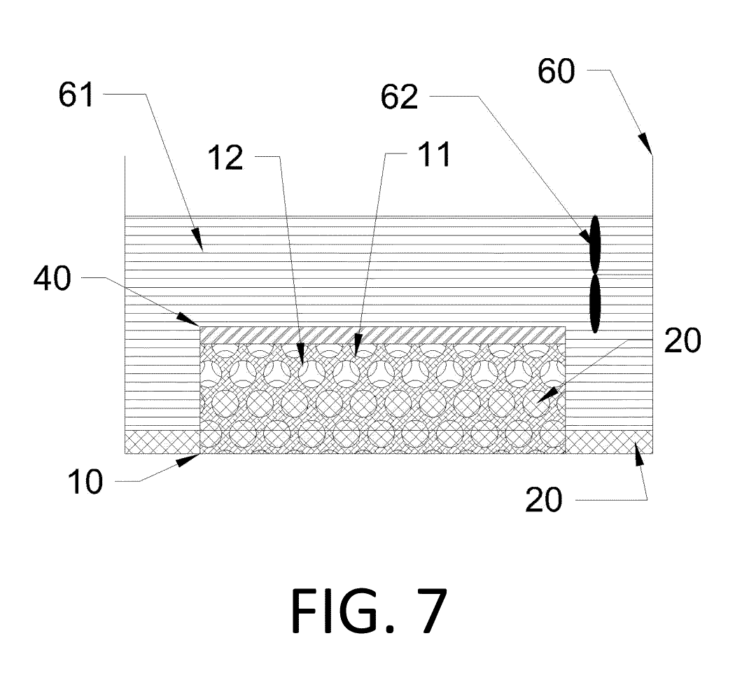

Referring to FIGS. 3 and 7, the purpose of the temporary filler material removal apparatus 60 is to provide a means of removing the temporary filler material 20 from the cellular matrix core 10 as a final step in the process. This occurs after the polymer filler material 40 has been introduced into the voids 12 of the cellular matrix core 10 and has fully solidified or cured. In the case of the low melting temperature Bismuth alloy, the temporary filler material removal apparatus consists of a material removal medium 61 which is a vat of hot water. As the Bismuth alloy starts melting, an agitator 62 is used to push the molten metal out of the cellular matrix core 10. The temporary filler material 20 vacates the cellular matrix core 10 leaving behind only the impregnated polymer filler material 40 at particular locations within the cellular matrix core 10.

In the case of granular solids as the temporary filler material 20, the temporary filler material removal apparatus 60 can take the form of a shaker that would allow the granular solids to flow out of the cellular matrix core 10. To aid in the removal of the granular solids from the cellular matrix core 10, the material removal medium 61 can take the form of a compressed air.

### Mold Cavity

Referring to FIGS. 5 and 6, the mold cavity 70 is an accessible three dimensional void that holds the cellular matrix core and gives shape to the temporary filler material so that the polymer filler material can occupy the remaining vacant space.

The purpose of the mold cavity is to hold the cellular matrix core 10 while the temporary filler material 20 and the polymer filler material 40 are introduced via the various apparatuses. The mold cavity 70 also serves the purpose of giving the final shape to the polymer filler material 40. The mold cavity 70 also serves the purpose of holding the temporary filler material 20 prior to the immersion of the cellular matrix core 10.

The mold cavity 70 could be made of a number of possible material including steel and aluminum. The design of the mold cavity should follow the standard practices associated with the types of temporary filler material and polymer filler material used.

### Alternative Embodiments of Invention

There are three groups of alternative variations of the invention.

The first group centers on the planar geometries of the polymer filler material possible within the open cell cellular matrix core. For this particular group, the process of filling the cellular matrix core with a low melting temperature Bismuth based alloy allows for the possibility of impregnating the cellular matrix core with multiple layers of polymer filler material thus adding to the structure of the core material. To perform this act, a similar operation as described in the embodiment of the invention would be performed, except the order in which the polymer filler material is introduced within the cellular matrix will vary. To achieve this feat the initial polymer filler layer would be introduced into the cellular matrix as described above. And, as described above, the temporary filler material would be removed using the same process. To allow for another layer of polymer filler material to be impregnated into the matrix core separated by a layer of unfilled foam, the outermost layer of the already impregnated polymer filler material would have to face down so that the low melting temperature Bismuth alloy can solidify on top of the polymer filler material. This can be done without negatively affecting the filler material since the alloy's melting temperature is far from the glass transition temperature of the polymer filler material. Once this layer of low melting temperature Bismuth alloy has solidified, the cellular matrix core can be filled with the polymer material. This process can be repeated to create multiple layers within the cellular matrix core.

The second group centers on angular planar geometries within the cellular matrix core while using the methods described by the preferred embodiment of the invention as well as the alternate embodiment that would create multiple layers within the open cell matrix core. To create these multiple angled layers the preform filler introduction apparatus would have to be tilted at a certain angle while the temporary filler material, still using the low melting temperature Bismuth alloy, solidifies at said angle. Using the steps presented in the explanation of the planar geometries within the cellular matrix core would allow for various angled layers in the cellular matrix core.

The third group revolves around creating radial geometries within the cellular matrix core. To fill a cylindrically shaped open cell cellular matrix core would require a cavity in which the cellular core is inserted. This cavity will have the function of rotating about its axis. This cavity will also have a means of allowing the temporary filler material to enter the cavity as it rotates about said axis without allowing it to escape the cavity. In this variation of the original embodiment, the temporary filler material will take the form of a low melting temperature Bismuth alloy. The cavity will be heated to aid in the flow of the low melting temperature Bismuth alloy to be introduced into the cavity. As the desired amount of melted alloy is introduced into the cavity, the cavity will be rotating at enough speed as to allow centrifugal forces to place the temporary filler material towards the outer edges of the cavity. While the cavity is rotating at these high speeds, the melted alloy will be allowed to solidify inside the cavity. Once the alloy has solidified, the vacant inner core will be filled with a second Bismuth alloy of a higher melting temperature than that of the previous step. Once the higher melting temperature Bismuth alloy has solidified, the lower melting temperature Bismuth alloy will be melted away using the temporary filler material removal apparatus of the original embodiment leaving behind a cellular matrix core that can only have the outer most layer filled with the desired polymer filler material. Once the desired volume has been filled, the inner most core would have the higher melting temperature Bismuth alloy removed in a similar fashion. This process can be repeated to allow for multiple concentric rings within the core.

### Operation of Preferred Embodiment

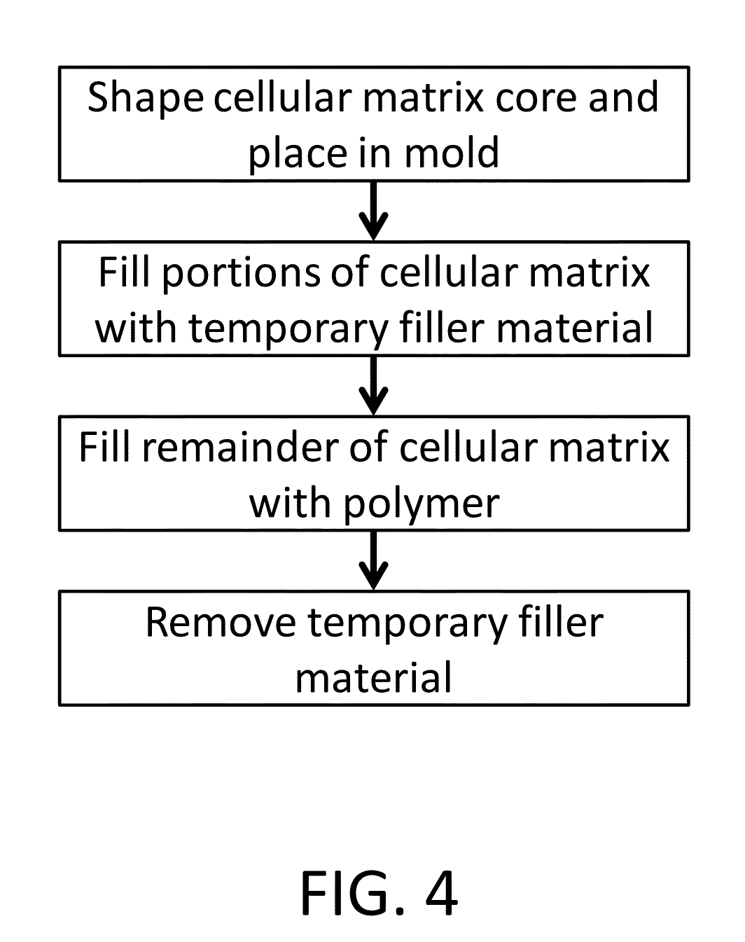

Referring to FIG. 4, in the preferred embodiment of the invention, the cellular matrix core 10 material is ERG's Series 6 Duocell open cell aluminum foam having interconnected ligaments 11 and voids 12 that allow viscous material to flow through it. The porosity of this foam is in the order of 90% (90% of a certain volume is air) and linear pore densities of 10, 20 or 40 pores per inch (PPI). The preform filler 20 is a low melting temperature Bismuth based alloy (a.k.a. Wood's metal) having a melting temperature of 152 degrees Farenheit. In its molten state, that alloy is able to readily flow through the voids 12 of the cellular matrix core 10. In the preferred embodiment, the filler material 40 is a polypropylene homopolymer. The intended final part is a flat sandwich structure with layers of polymer/aluminum foam forming both the top and bottom surfaces. In this embodiment, the aluminum foam extends to the outer surfaces, but could be designed to end a certain distance below the outer surface. In the latter case, the sandwich construction would include five layers: polymer, polymer/aluminum foam, aluminum foam, polymer/aluminum foam and polymer. In this embodiment, the filler material introduction apparatus is a 20 Ton capacity injection molding machine. The preform material removal apparatus 60 is a vat of boiling hot water acting as the material removal medium 61 that is near boiling temperature and an agitator 62 that forces the hot water through the cellular matrix core 10, thus evicting the Bismuth alloy.

The first step in the process is to shape the aluminum foam to the desired size. A mold with a cavity is heated to above the melting temperature of the Bismuth alloy. A prescribed amount of molten Bismuth alloy is then placed inside the cavity. While the Bismuth alloy is in the molten state, the aluminum foam is immersed into it which allows the molten metal to rise into the voids. The mold is then allowed to cool until the Bismuh alloy has solidified within the metal foam. The metal foam with the solidified Bismuth alloy is then moved to the mold of an injection molding machine. The Polypropylene homopolymer is injected into the vacant volume of the mold cavity as well as the unfilled voids of the aluminum foam. After the polypropylene solidifies, the filled aluminum foam is moved to a vat of hot water. The hot water melts the Bismuth alloy without damaging the polymer. Slight agitation of the water will drive the last vestiges of the Bismuth alloy out of the cellular matrix core (10). After the aluminum foam has been emptied of the Bismuth alloy and completely dried, it is placed back into the mold so that the opposite side of the aluminum foam can undergo the steps described above.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

What is claimed is:

1. A method of producing a layered construction of a composite of polymer and cellular metal, comprising:
providing a cellular metal core with open cell structure;
shaping the core to fit in a mold having a cavity with the desired net shape of the final product;
providing a temporary filler material that can flow through the open pores of the cellular metal core;
filling the open cells of the core with the temporary filler material at locations designed to remain vacant in the final product;
injecting a polymeric material through the volume of the core that was not filled by the temporary filler material;
and removing the temporary filler material thus creating a part with an open cellular metal layer, a polymer/cellular metal composite layer and a polymer only layer.

2. The method of claim 1 wherein the cellular metal core is an open-cell metal foam.

3. The method of claim 1 wherein the cellular metal core is woven metal wire material.

4. The method of claim 1 wherein the cellular metal core is a honeycomb-type material.

5. The method of claim 1 wherein the cellular metal core is an arrangement of wires joined together through welding, brazing or an adhesive.

6. The method of claim 1 wherein the temporary filler material is a Bismuth metal alloy with melting temperature less than 200 degree Fahrenheit.

7. The method of claim 6 wherein the temporary filler material is introduced into the core by pressing the core into a molten bath of the Bismuth alloy.

8. The method of claim 6 wherein the temporary filler material is introduced into the core by pouring the molten bath of the Bismuth alloy over the core.

9. The method of claim 6 wherein the temporary filler material is introduced into the core by the action of a centrifugal force.

10. The method of claim 1 wherein the temporary filler material is a granular ceramic material selected from a group consisting of sand, alumina, glass and plaster.

11. The method of claim 10 wherein the granular ceramic material is mixed with liquid to form a slurry.

12. The method of claim 1 wherein the cellular metal core is a metal shot or grit.

13. The method of claim 1 wherein the polymeric material is a thermoplastic.

14. The method of claim 13 wherein the thermoplastic is introduced into the core by means of traditional thermoplastic molding techniques such as injection molding and compression molding.

15. The method of claim 1 wherein the polymeric material is a thermosetting polymer.

16. The method of claim 15 wherein the thermosetting polymer is introduced into the core by means of positive pressure.

17. The method of claim 15 wherein the thermosetting polymer is introduced into the core by means of gravity.

18. The method of claim 6 wherein the temporary filler material is removed by an agitating or flushing bath of boiling water.

19. The method of claim 12 wherein the temporary filler material is removed by vibration under gravity or forced air.

20. A method of producing a layered construction of a composite of polymer and cellular metal, comprising:
providing a cellular metal core with open cell structure;
shaping the core to fit in a mold having a cavity with the desired net shape of the final product;
providing a first temporary filler material made of a metal alloy having melting temperature T1 that can flow through the open pores of the cellular metal core;
providing a second temporary filler material made of a metal alloy having melting temperature T2, where T2>T1, that can flow through the open pores of the cellular metal core;
filling the open cells of the core with the first temporary filler material having melting temperature T1 at the locations where the polymer is intended to be in the final product;
filling the remaining open cells of the core with the second temporary filler material having melting temperature T2;
removing first temporary filler material by heating the core to temperature T, where T2>T>T1;
injecting a polymeric material through the volume of the core that was not filled by the second temporary filler material;
and removing the second temporary filler material thus creating a part with an open cellular metal layer, a polymer/cellular metal composite layer and a polymer only layer.
